(19) United States
(12) Patent Application Publication
(10) Pub. No.: US 2023/0281730 A1
(43) Pub. Date: Sep. 7, 2023

(54) NEURAL NETWORK FOR MODEL-BLENDED TIME SERIES FORECAST

(71) Applicant: Microsoft Technology Licensing, LLC, Redmond, WA (US)

(72) Inventors: Abir CHAKRABORTY, Bangalore (IN); Shivkumar KALYANARAMAN, Bangalore (IN)

(73) Assignee: Microsoft Technology Licensing, LLC, Redmond, WA (US)

(21) Appl. No.: 17/653,262

(22) Filed: Mar. 2, 2022

(51) Int. Cl. G06Q 50/06; G06Q 10/04; G06N 3/04

(52) U.S. Cl. CPC G06Q 50/06; G06Q 10/04; G06N 3/0454

(57) ABSTRACT

A computer system is provided, including a processor and associated memory storing instructions that when executed cause the processor to implement a plurality of artificial intelligence (AI) models. Each AI model is configured to receive, as input, time series data and to output a model-specific time series forecast including a respective predicted value for each of a plurality of future time steps. The processor is further configured to implement a model selection neural network configured to select a predicted most accurate AI model from among the plurality of AI models for each of the plurality of future time steps. The processor is further configured to implement a blended output generator configured to output a model-blended time series forecast including the respective predicted value computed by the predicted most accurate AI model selected for each of the plurality of future time steps.

### BACKGROUND

Time series forecasts use models to predict future values of a series data points indexed in time-order, based on past observations. Time series forecasting has application in a wide variety of technical fields. One such field is renewable energy forecasting. The global supply and demand for renewable energy such as solar and wind power has grown rapidly, as concern for climate change and demand for cleaner energy sources accelerates. Renewable energy sources such as solar and wind intermittently produce power, with power output changing based on environmental conditions that vary, such as the weather and available sunlight. Demand for renewable energy sources also varies with changing environment conditions, such as temperature, and also with the variation in human activities. A technical challenge exists to developing models for accurate and efficient forecasting of time series for phenomena such as these that vary based on a complex set of factors.

### SUMMARY

A computer system and method are provided. The computing system includes a processor and associated memory storing instructions that when executed cause the processor to implement a plurality of AI models. Each AI model is configured to receive, as input, time series data and to output a model-specific time series forecast including a respective predicted value for each of a plurality of future time steps. The processor is further configured to implement a model selection neural network configured to select a predicted most accurate AI model from among the plurality of AI models for each of the plurality of future time steps. The processor is further configured to implement a blended output generator configured to output a model-blended time series forecast including the respective predicted value computed by the predicted most accurate AI model selected for each of the plurality of future time steps. The processor is further configured to implement a reward function module configured to, in a training phase, reward or penalize the model selection neural network via a reward function module that computes a reward or penalty based on an error difference between the respective predicted value of the predicted most accurate AI model and an actual value for each of the plurality of future time steps.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 shows a schematic view of an example computing system including an energy resource controller configured to output a command to an electrical system based on predicted values computed by a reinforcement learning (RL) system, according to one example configuration of the present disclosure.

FIG. 2 shows a schematic view of the RL system of the computing system of FIG. 1, including a model selection neural network configured to select a predicted most accurate AI model from among the plurality of AI models for each of the plurality of future time steps and output a model-blended time series forecast for each of the plurality of future time steps.

FIG. 3 shows a schematic view of an example model-specific time series forecast generated via the plurality of AI models of the RL system shown in FIG. 2, with different output ranges for each of the plurality of future time steps.

FIG. 4 shows a schematic view of an example model-blended time series forecast generated by the RL system based on the example model-specific time series forecast of FIG. 2.

FIGS. 5A and 5B show an example of an error and penalty value of a reward function computed via a reward function module of FIG. 2, which trains the model selection neural network.

FIG. 6 shows a flowchart of a computerized method according to one example implementation of the present disclosure.

FIG. 7 shows an example computing environment according to which the embodiments of the present disclosure may be implemented.

### DETAILED DESCRIPTION

As briefly discussed above, time series forecasting is an approximation task which aims to estimate future values of observations based on current and past values of a time-indexed sequence and develop a model describing the underlying relationship. Different models may be developed that produce predictions for different periods of time. In the field of renewable energy prediction, for example, different time series forecasting models may be used to generate long-term predictions for a longer period such as a 24-hour prediction period, and short-term predictions for a shorter period such as a 3-hour prediction period. Generally, a short-term prediction model produces more accurate results than a long-term prediction model; however, it has been observed that long-term prediction models outperform short-term prediction models under certain circumstances for certain time periods. Thus, utilizing a single prediction model has the drawback that certain time period estimates by the chosen model may be less accurate than predictions made by other models.

To address this issue and increase the accuracy of time series forecasts, a computing system is disclosed herein that is configured to select, via a model selection neural network, a predicted most accurate AI model for each of a plurality of future time steps from among a plurality of AI models, in which the model selection neural network is trained to minimize an error difference between the respective predicted value of the predicted most accurate AI model and an actual value for each of the future time steps. The model selection neural network is constantly trained to select a predicted most accurate AI model for each of the future time steps to attempt to forecast a most accurate predicted value that is the closest to an actual value, and thus the system can borrow from the strengths of all available models, and learn to predict a more accurate overall forecast. Such a more accurate forecast, in the field of renewable energy, for example, allows the energy grid to be managed so as to better optimize the production, transmission, and usage of intermittent power sources such as solar and wind power under varying demand conditions.

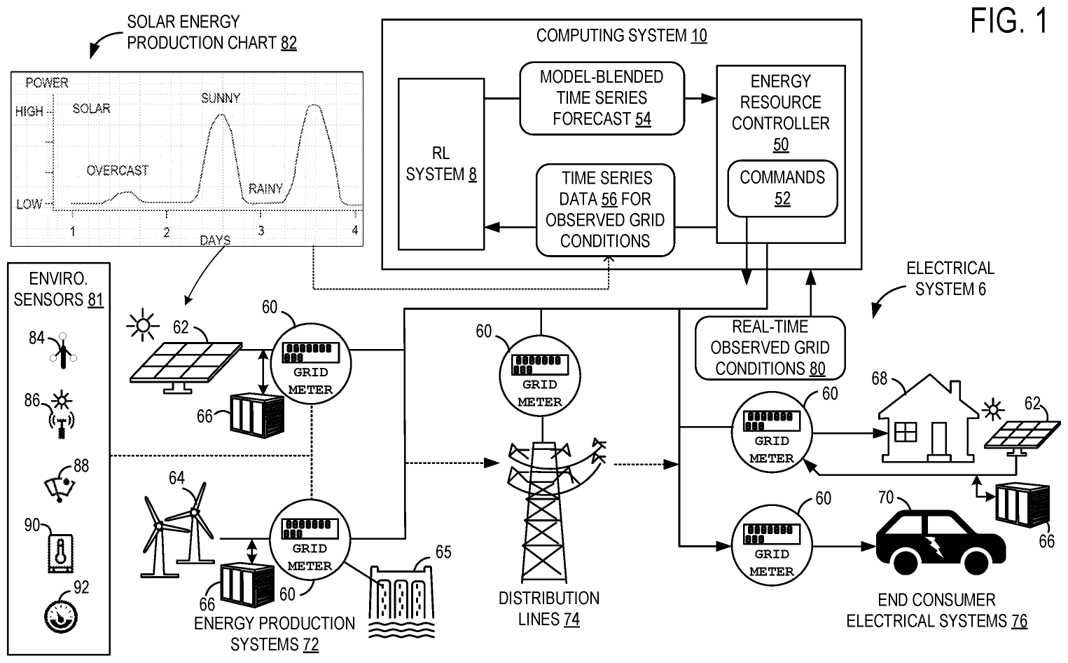

FIG. 1 shows a schematic view of an example computing system 10 including an energy resource controller 50 configured to output a command 52 to an energy resource of an electrical system 6 based on predicted values 54 computed by a reinforcement learning (RL) system 8. The electrical system 6 may include energy resources such as energy production systems 72, distribution lines 74, and end consumer electrical systems 76. The electrical system 6 may selectively transmit, via the distribution lines 74, power along a path within a network of transmission lines from the energy production systems 72 to end consumer electrical systems 76. The energy resource controller 50 of the computing system 10 may be connected to the energy production systems 72, the distribution lines 74, and the end consumer electrical systems 76 through grid meters 60 to obtain real-time observed grid conditions 80 and perform control, allocation, and/or optimization of an energy resource such as a solar array 62, wind turbine 64, hydroelectric generator 65, or battery 66.

In this example, the energy production systems 72 include solar panels 62 and wind turbines 64. Batteries 65 for storage of energy are also provided. The end consumer electrical systems 76 include residential homes 68 and electric cars 70. The grid meters 60 are provided for each energy production systems 72, distribution lines 74, and end consumer electrical systems 76. The grid meters 60 may measure electrical production and electrical usage at a plurality of points across the electrical system 6. The grid meters 60 may further provide sensors that both detect the rate of power traveling through the meter and, in some cases, control an associated element of the power grid, such as power production, storage, distribution, or consumption. The energy resource controller 50 of the computing system 10 receives electrical production data and electrical usage data from the grid meters 60.

Renewable energy production typically exhibits a large amount of variability across space (different locations), time (times of the day, seasons, etc.), and different resources (solar, wind, etc.). As shown in a prophetic example of a solar energy production chart 82, solar energy typically follows a periodic diurnal pattern. Overcast sky conditions with heavy clouds during the day can significantly reduce a peak production, while sunny sky conditions achieve the peak production. The changing seasons of the year may similarly cause variability among the peak energy production of a solar energy source. For example, the peak energy production in winter may potentially be less than the peak energy production in summer. In a similar manner, wind energy sources also have sharp peaks and valleys that may frequently change depending on weather conditions. For example, the peak energy production on a calm day may potentially be less than the peak energy production on a day with high winds. Likewise, energy consumption by the end consumer electrical systems 76 also varies across different locations, time, and weather conditions. For instance, hot weather typically increases demand for cooling and energy consumption. These variations can be tracked as sensor readings at a series of time steps to form time series data 56 for observed grid conditions 80. The time series data 56 may also include measurements of or from environmental sensors 81 such as a wind sensor 84, sunlight sensor 86, rain sensor 88, temperature sensor 90, and barometric pressure sensor 92. The time series data 56 including the electrical production data, consumption data, and environmental data may be communicated to the computing system 10 as the real-time observed grid conditions 80, which is utilized to train the reinforcement learning (RL) system 8 to generate a model-blended time series forecast 54 including predicted values as discussed below, through the grid meters 60.

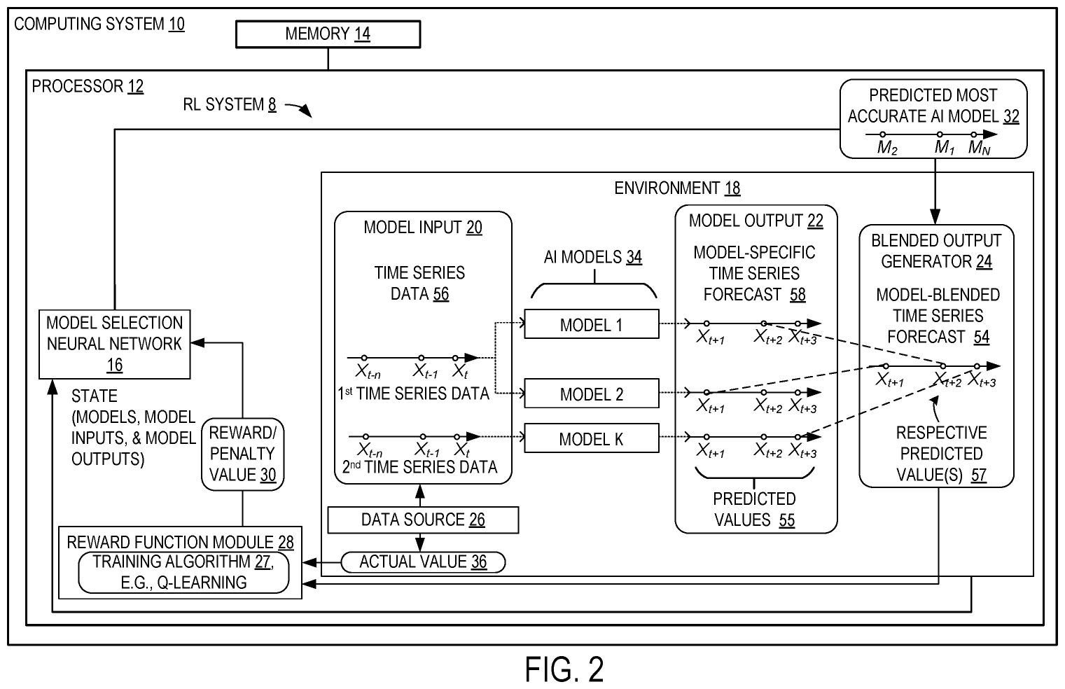

FIG. 2 shows a schematic view of the computing system 10 including a processor 12 configured to implement a plurality of AI models 34, a model selection neural network 16 configured to select a predicted most accurate AI model 32 from among the plurality of AI models 34 for each of the plurality of future time steps, and a blended output generator 24 configured to output a model-blended time series forecast 54 for each of the plurality of future time steps.

The computing system 10 may include one or more processors 12 having associated memory 14, and may be configured to execute instructions using portions of memory 14 to perform the functions and processes of the computing system 10 described herein. For example, the computing system 10 may include a cloud server platform including a plurality of server devices, and the one or more processors 12 may be one processor of a single server device, or multiple processors of multiple server devices. The computer system 10 may also include one or more client devices in communication with the server devices, and one or more of processors 12 may be situated in such a client device. Typically, training and run-time operations of the model selection neural network 16 are executed on different devices (e.g., a first computing device and a second computing device) of the computer system, although they may be executed by the same device. Below, the functions of computing system 10 as executed by processor 12 is described by way of example, and this description shall be understood to include execution on one or more processors distributed among one or more of the devices discussed above.

Continuing with FIG. 2, the computing system 10 is configured to implement a plurality of AI models 34, in which each AI model 34 is configured to receive, as input, time series data 56 (Xₜ₋₁, Xₜ₋₂, Xₜ₋₃ . . . ) and to output a model-specific time series forecast 58 including a respective predicted value 57 for each of a plurality of future time steps. At a model input 20, the time series data 56 may include measurements of or from a data source 26 including the sensors 81 such as the wind sensor 84, sunlight sensor 86, rain sensor 88, temperature sensor 90, and/or barometric pressure sensor 92, as shown in FIG. 1 and discussed above. Each of these sensors may be positioned adjacent the energy resource as a local in-situ sensor, or further afield as a remote sensor. The time series data 56 may be historical data, weather monitoring station data, or satellite data measured by those sensors above. For instance, as shown in the solar energy production chart 82 of FIG. 1, the historical data of a solar power production can be tracked at a series of time steps to form the time series data 56.

The plurality of AI models 34, configured to receive the time series data 56 as input, may be machine learning forecasting models that are configured to generate predicted values 55 for future time steps of respective different output ranges at model output 22. The respective different output ranges include a long-term output range, and a short-term output range that is shorter than the long-term output range. For example, the respective different output ranges may include 1.5 hour, 3 hour, 6 hour, and 24 hour ranges. For the 3-hour range, the AI model generates predicted values 55 for future time steps (e.g., six future time steps) of the 3-hour range at certain interval (e.g., 15 min) as discussed in detail below. As shown in a model output 22, each AI model 34 generates its own model-specific time series forecast 58 including the predicted values 55 (Xₜ₊₁, Xₜ₊₂, Xₜ₊₃ . . . ) for each of the future time steps. That is, each of the predicted values 55 is provided by each AI model 34 for each future time step, and N of the predicted values 55 are provided for each of the time steps when there are an K number of AI models 34 utilized.

Continuing with FIG. 2, the computing system 10 is configured to implement the model selection neural network 16 configured to select a predicted most accurate AI model 32 from among the plurality of AI models 34 for each of the plurality of future time steps. The computing system 10 is further configured to implement a blended output generator 24 configured to output a model-blended time series forecast 54 including the respective predicted value 57 computed by the predicted most accurate AI model 32 selected for each of the plurality of future time steps. The model-blended time series forecast 54 including the respective predicted values 57 is transmitted to a reward function module 28 that trains the model selection neural network 16. This model-blended time series forecast has the potential technical benefit that the system can under many conditions forecast a more accurate set of predicted values, applying the strengths of all available models including the short-term output models and long-term output models, as compared to using a single model for forecasting.

In a training phase, as discussed above, the model selection neural network 16 may be trained using reinforcement learning. Reinforcement learning is a type of machine learning technique that enables an agent to learn in an interactive environment by trial and error using feedback from its own actions and experiences. The agent receives rewards for performing correctly and penalties for performing incorrectly. The agent learns without intervention from a human by maximizing its reward and minimizing its penalty. In the depicted example of FIG. 2, the model selection neural network 16 as an agent may be trained using reinforcement learning via the reward function module 28 that computes a reward or penalty value 30, based on an error difference between the respective predicted value 57 of the predicted most accurate AI model 32 and the actual value 36 for each of the plurality of future time steps, and updates the network according to a training algorithm 27. Using reinforcement learning in this manner provides the potential technical benefit that the user may specify reward policies and the system may train itself over time based upon those policies to improve its accuracy at each time step.

The reward or penalty value 30 is utilized via the reward function module 28 to train the model selection neural network 16 by utilizing the training algorithm 27 (e.g., Q-Learning) that updates its own weights based on the calculated reward or penalty value 30. The reward function module 28 may further specify that a penalty is applied when the error difference is greater than a predetermined value. In its most general form, the model selection network 16 is a deep neural network model q_{θ} (with parameters θ) that emits a probability distribution over the K number of AI models and the AI model with the highest probability is chosen, i.e., model output aₜ∈[1, . . . K]. Given the action aₜ=k, the corresponding forecast yₜ=Mₖ(fₜ) where Mₖ is the k-th AI model and fₜ is the input feature at time-t. The reward may be defined as rₜ=r(yₜ)=−∥yᵣ−\tilde{y}ₜ∥, where yₜ is the AI model output and \tilde{y}ₜ is the actual value to be know later. The reward can also be defined in terms of aₜ as is the case with multi-armed bandit model (shown next). Furthermore, it will be appreciated that one embodiment of the model selection neural network 16 may be configured as a multi-armed bandit. The multi-armed bandit problem is a classic reinforcement learning example, in which a slot machine has N arms (bandits) with each arm having its own rigged probability distribution of success. Pulling any one of the arms gives a stochastic reward of either R=+1 for success, or R=0 for failure. The objective is to pull the arms one-by-one in sequence such that the total reward collected in the long run is maximized. In the depicted example, each of the plurality of AI models 34 may be an arm of the multi-arm bandit with different rewards, in which there are an K number of AI models 34. Under Bernoulli bandits, if the k-th model is chosen, i.e., aₜ=k, the rewards rₜ=1 when the model selected has the best accuracy or rₜ=0 otherwise. In this case, p(rₜ=1|fₜ)=θₖ and p(rₜ=0|fₜ)=1−θₖ, where θₖ is the parameter associated with the k-th arm (AI model) and can be assumed to be beta-distributed with parameter αₖ and βₖ. These parameters can be updated based on the following rule:

$$( {α}_{k} , {β}_{k} ) ← \{ \begin{matrix}( {α}_{k} , {β}_{k} ) & if the k - th model is not selected \\ ( {α}_{k} , {β}_{k} ) + ( {r}_{t} , 1 - {r}_{t} ) & if the k - th model is selected\end{matrix}$$

Thus, for Bernoulli bandit, parameters of the model selection network 16 takes the simple form of θ=[θ₁, . . . , θ_{K}].

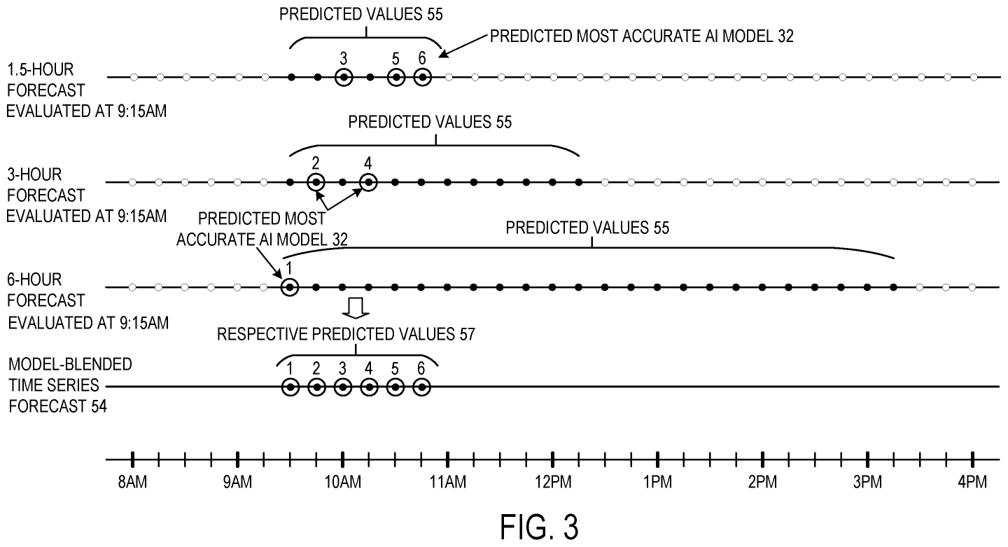

FIG. 3 shows a schematic view of an example model-specific time series forecast 58 of solar/wind power production generated via the plurality of AI models 34 with different output ranges for each of the plurality of future time steps. In the depicted example, three different AI models with different time ranges—1.5-hour forecast model, 3-hour forecast model, and 6-hour forecast model—are implemented. Each AI model that is evaluated at 9:15 a.m. forecasts at 15 minute intervals in the depicted example. The 1.5-hour model generates the predicted values 55 for six future time steps from 9:30 a.m. to 10:45 a.m. The 3-hour model generates the predicted values 55 for twelve future time steps from 9:30 a.m. to 12:15 p.m. The 6-hour model generates the predicted values 55 for twenty-four future time steps from 9:30 a.m. to 3:15 p.m. Thus, three different predicted values are generated by the three different AI models for each of the time steps from 9:15 a.m. to 10:45 a.m., and the most accurate AI model 32 is selected for each time step as shown at (1)-(6) in FIG. 3. The respective predicted values 57 from each of the selected most accurate AI models 32 at each time step, shown at (1)-(6) are collected to form the model-blended time series forecast 54.

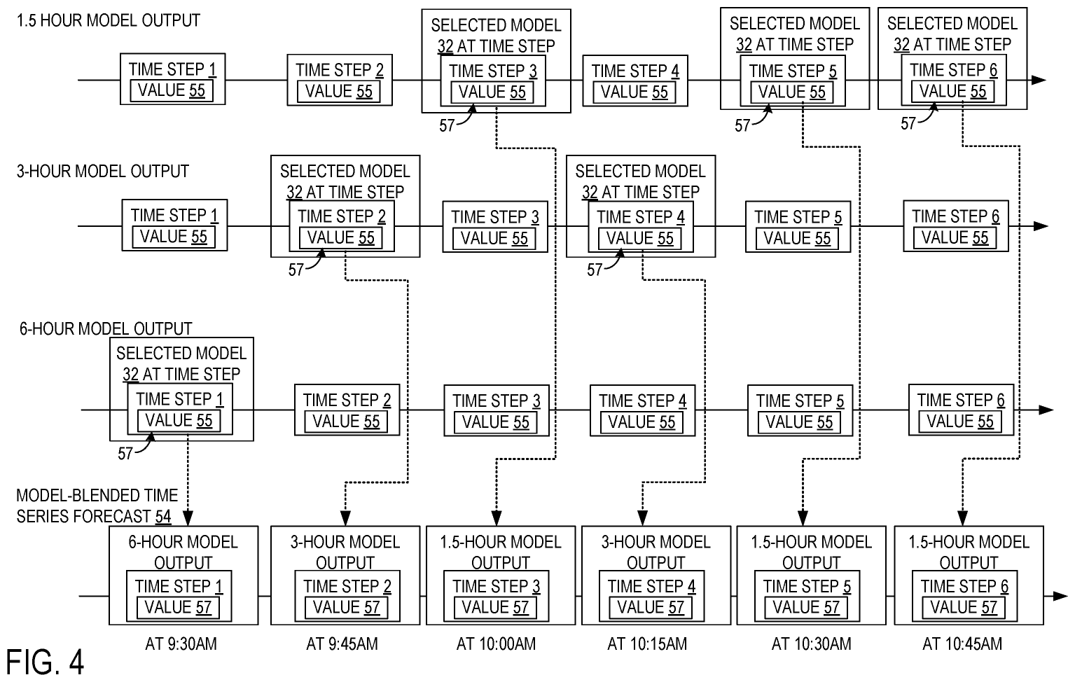

Turning briefly to FIG. 4, selection of the predicted most accurate AI model 32 is further explained. FIG. 4 shows a schematic view of an example model-blended time series forecast 54 formed based on the example model-specific time series forecast 58 of FIG. 3. In the depicted example, the predicted most accurate AI model 32 from among the 1.5-hour model, 3-hour model, and 6-hour model is selected by the model selection neural network 16 for each of the time step. The 6-hour model is selected at 9:30 a.m.; the 3-hour model is selected at 9:45 a.m.; the 1.5 hour model is selected at 10 a.m.; the 3-hour model is selected at 10:15 a.m.; the 1.5 hour model is selected at 10:30 a.m.; and the 1.5 hour model is selected at 10:45 a.m. As a result, the model-blended time series forecast 54 including the respective predicted value 57 computed by the predicted most accurate AI model 32 selected for 9:30 a.m., 9:45 a.m., 10:00 a.m., 10:15 a.m., and 10:30 a.m., respectively, is generated and output to the reward function module 28 via the blended output generator 24. An error and/or penalty values are computed utilizing the respective predicted value 57 and the actual value 36 to train the model selection neural network 16, as discussed below.

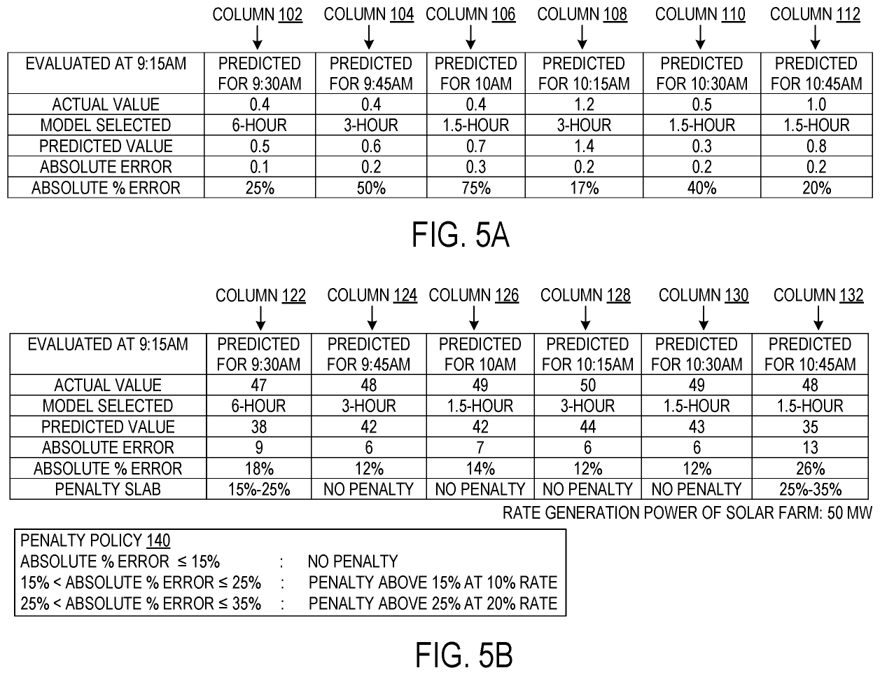

FIGS. 5A and 5B show an example of an error and penalty value of a reward function computed via the reward function module 28 that trains the model selection neural network 16 for predicting solar power generation. As shown in FIG. 5A, an absolute error for each time step using the example of FIG. 3 and FIG. 4 is calculated. For 9:30 a.m. as shown in column 102, the actual value 36 is 0.4 MW and the respective predicted value 57 of the predicted most accurate AI model 32, which is the 6-hour model, is 0.5 MW. The absolute error value is 0.1 MW (0.5 MW−0.4 MW) and the absolute percentage error is computed as 25% (0.1 MW÷0.4 MW×100). For 9:45 a.m. as shown in column 104, the actual value is 0.4 MW and the respective predicted value 57 of the predicted most accurate AI model 32, which is the 3-hour model, is 0.6 MW. The absolute error value is 0.2 MW (0.6 MW−0.4 MW) and the absolute percentage error is computed as 50% (0.2 MW÷0.4 MW×100). In the same manner, the absolute errors and percentage errors are computed for 10 a.m., 10:15 a.m., 10:30 a.m., and 10:45 a.m. as shown in columns 106, 108, 110, and 112. The computed absolute error and penalty value is utilized by the reward function module 28 to train the model selection neural network 16 with the training algorithm 27. Alternatively, it will be appreciated that the error may be computed based on a difference between the respective predictive value 57 of the predicted most accurate AI model 32 and the respective predicted value of an AI model that is closest to the actual value. For instance, for 9:45 a.m. as shown in column 104, when the AI model that is the closet to the actual value is the 6-hour model and the respective predicted value of the 6-hour model is 0.5 MW, the corresponding absolute error is 0.1 MW (0.5 MW−0.4 MW). A modified error is calculated based on the absolute error (0.2 MW) by the predicted most accurate AI model 32 (3-hour model) and the absolute error (0.1 MW) by the closest model (6-hour model), and the modified error value is utilized to train the model selection neural network 16.

Turning to FIG. 5B, a penalty may be determined based on the absolute error and utilized as a reward function to train the model selection neural network 16. As shown in FIG. 5B, a penalty for each time step using the example of FIG. 3 and FIG. 4 is determined. For 9:30 a.m. as shown in column 122, the actual value 36 is 47 MW and the respective predicted value 57 of the predicted most accurate AI model 32, which is the 6-hour model, is 38 MW. The absolute error value is 9 MW (47 MW−38 MW) and the absolute percentage error is computed as 18% (9 MW÷50 MW×100), given that a rate generation power of a solar farm is 50 MW. A penalty slab (i.e., a penalty category according to the penalty policy) is determined according to a penalty policy 140. Since the absolute percentage error of 18% falls within a range of 15%-25%, a predetermined penalty for the 15%-25% range is applied. For 9:45 a.m. as shown in column 124, the actual value is 48 MW and the respective predicted value 57 of the predicted most accurate AI model 32, which is the 3-hour model, is 42 MW. The absolute error value is 6 MW (48 MW−42 MW) and the absolute percentage error is computed as 12% (6 MW÷50 MW×100). Since the absolute percentage error of 12% falls within a range of 0%-15%, no penalty is applied according to the penalty policy 140. In the same manner, penalty is determined for 10 a.m., 10:15 a.m., 10:30 a.m., and 10:45 a.m. as shown in columns 126-132. The determined penalties are used by the reward function module 28 to train the model selection neural network 16 with the training algorithm 27. Alternatively, a continuous penalty function, such as a linear or non-linear function, may be used rather than discontinuous penalty slabs as in the example above.

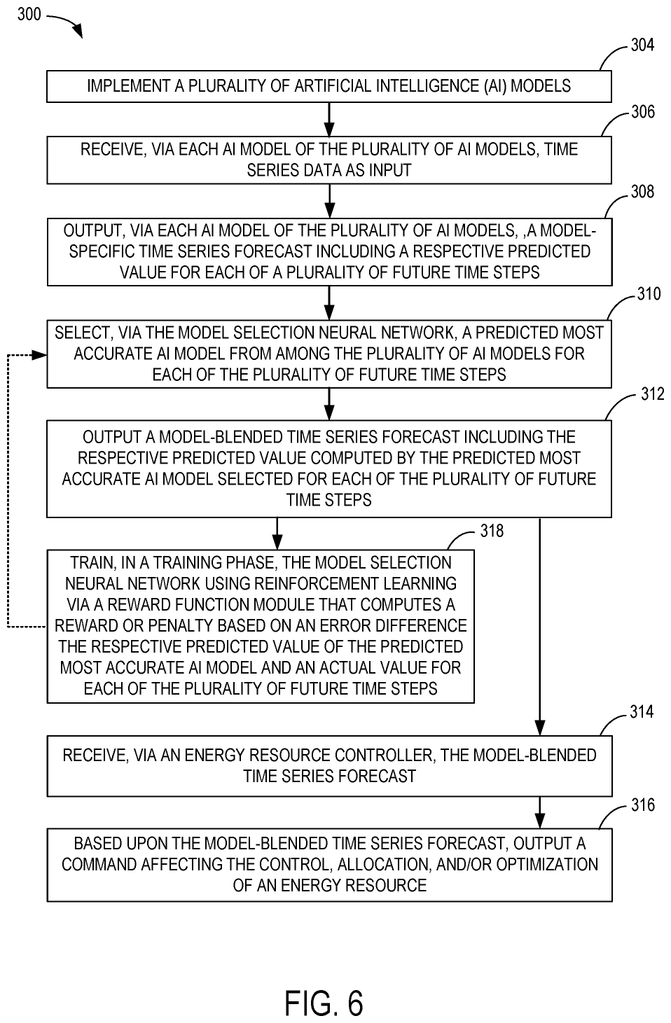

FIG. 6 shows a flowchart of a computerized method 300 according to one example implementation of the computing system of FIG. 2. At step 304, the method may include implementing a plurality of artificial intelligence (AI) models. The plurality of AI models may include models that are configured to generate predicted values for future time steps of respective different output ranges. The respective different output ranges may include a long-term output range and a short-term output range that is shorter than the long-term output range, such as 1.5 hour, 3 hour, 6 hour, and 24 hour ranges. At step 306, the method may further include receiving, via each AI model of the plurality of AI models 34, time series data as input. The time series data may include measurements of (or from) a wind sensor, sunlight sensor, rain sensor, temperature sensor, and/or barometric pressure sensor. At step 308, the method may further include outputting, via each AI model of the plurality of AI models 34, a model-specific time series forecast including a respective predicted value for each of a plurality of future time steps. At step 310, the method may further include selecting, via a model selection neural network, a predicted most accurate AI model 32 from among the plurality of AI models 34 for each of the plurality of future time steps. At step 312, the method may further include outputting a model-blended time series forecast including the respective predicted value computed by the predicted most accurate AI model 32 selected for each of the plurality of future time steps. At step 314, the method may further include receiving, via an energy resource controller, the model-blended time series forecast. At step 316, the method may further include, based upon the model-blended time series forecast, outputting, via the energy resource controller, a command affecting the control, allocation, and/or optimization of an energy resource. At step 318, the method may further include training, in a training phase, the model selection neural network 16 using reinforcement learning via a reward function module that computes a reward or penalty based on an error difference between the respective predicted value of the predicted most accurate AI model and an actual value for each of the plurality of future time steps. The reward function module may specify that a penalty is applied when the error difference is greater than a predetermined value. Looping back to step 310, the trained model selection neural network 16 may be utilized to select a predicted most accurate AI model from among the plurality of AI models for each of the plurality of future time steps. This method has the potential technical benefit of forecasting a more accurate predicted value that is the closest to an actual value for each time step, applying the strengths of all available models, as compared to single model approaches.

In some embodiments, the methods and processes described herein may be tied to a computing system of one or more computing devices. In particular, such methods and processes may be implemented as a computer-application program or service, an application-programming interface (API), a library, and/or other computer-program product.

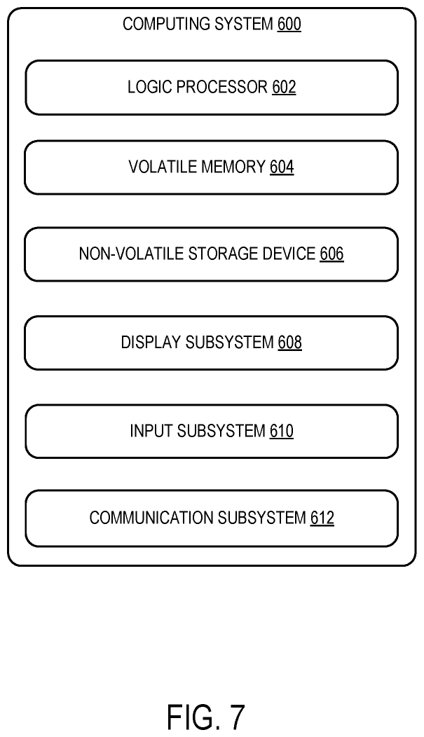

FIG. 7 schematically shows a non-limiting embodiment of a computing system 600 that can enact one or more of the methods and processes described above. Computing system 600 is shown in simplified form. Computing system 600 may embody the computer device 10 described above and illustrated in FIGS. 1 and 2. Computing system 600 may take the form of one or more personal computers, server computers, tablet computers, home-entertainment computers, network computing devices, gaming devices, mobile computing devices, mobile communication devices (e.g., smart phone), and/or other computing devices, and wearable computing devices such as smart wristwatches and head mounted augmented reality devices.

Computing system 600 includes a logic processor 602 volatile memory 604, and a non-volatile storage device 606. Computing system 600 may optionally include a display subsystem 608, input subsystem 610, communication subsystem 612, and/or other components not shown in FIG. 7.

Logic processor 602 includes one or more physical devices configured to execute instructions. For example, the logic processor may be configured to execute instructions that are part of one or more applications, programs, routines, libraries, objects, components, data structures, or other logical constructs. Such instructions may be implemented to perform a task, implement a data type, transform the state of one or more components, achieve a technical effect, or otherwise arrive at a desired result.

The logic processor may include one or more physical processors (hardware) configured to execute software instructions. Additionally, or alternatively, the logic processor may include one or more hardware logic circuits or firmware devices configured to execute hardware-implemented logic or firmware instructions. Processors of the logic processor 602 may be single-core or multi-core, and the instructions executed thereon may be configured for sequential, parallel, and/or distributed processing. Individual components of the logic processor optionally may be distributed among two or more separate devices, which may be remotely located and/or configured for coordinated processing. Aspects of the logic processor may be virtualized and executed by remotely accessible, networked computing devices configured in a cloud-computing configuration. In such a case, these virtualized aspects are run on different physical logic processors of various different machines, it will be understood.

Non-volatile storage device 606 includes one or more physical devices configured to hold instructions executable by the logic processors to implement the methods and processes described herein. When such methods and processes are implemented, the state of non-volatile storage device 606 may be transformed—e.g., to hold different data.

Non-volatile storage device 606 may include physical devices that are removable and/or built-in. Non-volatile storage device 606 may include optical memory (e.g., CD, DVD, HD-DVD, Blu-Ray Disc, etc.), semiconductor memory (e.g., ROM, EPROM, EEPROM, FLASH memory, etc.), and/or magnetic memory (e.g., hard-disk drive, floppy-disk drive, tape drive, MRAM, etc.), or other mass storage device technology. Non-volatile storage device 606 may include nonvolatile, dynamic, static, read/write, read-only, sequential-access, location-addressable, file-addressable, and/or content-addressable devices. It will be appreciated that non-volatile storage device 606 is configured to hold instructions even when power is cut to the non-volatile storage device 606.

Volatile memory 604 may include physical devices that include random access memory. Volatile memory 604 is typically utilized by logic processor 602 to temporarily store information during processing of software instructions. It will be appreciated that volatile memory 604 typically does not continue to store instructions when power is cut to the volatile memory 604.

Aspects of logic processor 602, volatile memory 604, and non-volatile storage device 606 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs).

The terms “module,” “program,” and “engine” may be used to describe an aspect of computing system 600 typically implemented in software by a processor to perform a particular function using portions of volatile memory, which function involves transformative processing that specially configures the processor to perform the function. Thus, a module, program, or engine may be instantiated via logic processor 602 executing instructions held by non-volatile storage device 606, using portions of volatile memory 604. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

When included, display subsystem 608 may be used to present a visual representation of data held by non-volatile storage device 606. The visual representation may take the form of a graphical user interface (GUI). As the herein described methods and processes change the data held by the non-volatile storage device, and thus transform the state of the non-volatile storage device, the state of display subsystem 608 may likewise be transformed to visually represent changes in the underlying data. Display subsystem 608 may include one or more display devices utilizing virtually any type of technology. Such display devices may be combined with logic processor 602, volatile memory 604, and/or non-volatile storage device 606 in a shared enclosure, or such display devices may be peripheral display devices.

When included, input subsystem 610 may comprise or interface with one or more user-input devices such as a keyboard, mouse, touch screen, or game controller. In some embodiments, the input subsystem may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity; and/or any other suitable sensor.

When included, communication subsystem 612 may be configured to communicatively couple various computing devices described herein with each other, and with other devices. Communication subsystem 612 may include wired and/or wireless communication devices compatible with one or more different communication protocols. As non-limiting examples, the communication subsystem may be configured for communication via a wireless telephone network, or a wired or wireless local- or wide-area network, such as a HDMI over Wi-Fi connection. In some embodiments, the communication subsystem may allow computing system 600 to send and/or receive messages to and/or from other devices via a network such as the Internet.

The following paragraphs discuss several aspects of the present disclosure. According to one aspect of the present disclosure, a computing system is provided. The computing system may include a processor and associated memory storing instructions that when executed cause the processor to implement a plurality of artificial intelligence (AI) models, in which each AI model is configured to receive, as input, time series data and to output a model-specific time series forecast including a respective predicted value for each of a plurality of future time steps. The processor may be further configured to implement a model selection neural network configured to select a predicted most accurate AI model from among the plurality of AI models for each of the plurality of future time steps. The processor may be further configured to implement a blended output generator configured to output a model-blended time series forecast including the respective predicted value computed by the predicted most accurate AI model selected for each of the plurality of future time steps.

According to this aspect, the plurality of AI models may include models that are configured to generate predicted values for future time steps of respective different output ranges.

According to this aspect, the respective different output ranges may include a long-term output range, and a short-term output range that is shorter than the long-term output range.

According to this aspect, the respective different output ranges may include 1.5 hour, 3 hour, 6 hour, and 24 hour ranges.

According to this aspect, in a training phase, the model selection neural network may be trained using reinforcement learning via a reward function module that computes a reward or penalty based on an error difference between the respective predicted value of the predicted most accurate AI model and an actual value for each of the plurality of future time steps.

According to this aspect, the reward function module may specify that a penalty is applied when the error difference is greater than a predetermined value.

According to this aspect, the model selection neural network may be configured as a multi-armed bandit, each AI model being an arm of the multi-armed bandit.

According to this aspect, the time series data may include measurements of or from a wind sensor, sunlight sensor, rain sensor, temperature sensor, and/or barometric pressure sensor.

According to this aspect, the time series data may include measurements of historical data, weather monitoring station data, or satellite data.

According to this aspect, the computer system may further include an energy resource controller configured to receive the model-blended time series forecast and output a command affecting control, allocation, and/or optimization of an energy resource, based upon the model-blended time series forecast.

According to this aspect, the energy resource may be selected from the group consisting of a solar array, wind turbine, hydroelectric generator and battery.

According to another aspect of the present disclosure, a computerized method is provided. The computerized method may include implementing a plurality of artificial intelligence (AI) models. The computerized method may further include receiving, via each AI model of the plurality of AI models, time series data as input. The computerized method may further include outputting, via each AI model of the plurality of AI models, a model-specific time series forecast including a respective predicted value for each of a plurality of future time steps. The computerized method may further include selecting, via a model selection neural network, a predicted most accurate AI model from among the plurality of AI models for each of the plurality of future time steps. The computerized method may further include outputting a model-blended time series forecast including the respective predicted value computed by the predicted most accurate AI model selected for each of the plurality of future time steps.

According to this aspect, the plurality of AI models may include models that are configured to generate predicted values for future time steps of respective different output ranges.

According to this aspect, the respective different output ranges may include a long-term output range, and a short-term output range that is shorter than the long-term output range.

According to this aspect, the respective different output ranges may include 1.5 hour, 3 hour, 6 hour, and 24 hour ranges.

According to this aspect, the computerized method may further include training, in a training phase, the model selection neural network using reinforcement learning via a reward function module that computes a reward or penalty based on an error difference between the respective predicted value of the predicted most accurate AI model and an actual value for each of the plurality of future time steps.

According to this aspect, the reward function module may specify that a penalty is applied when the error difference is greater than a predetermined value.

According to this aspect, the time series data may include measurements of or from a wind sensor, sunlight sensor, rain sensor, temperature sensor, and/or barometric pressure sensor.

According to this aspect, the computerized method may further include receiving, via an energy resource controller, the model-blended time series forecast and outputting a command affecting the control, allocation, and/or optimization of an energy resource, based upon the model-blended time series forecast.

According to another aspect of the present disclosure, a computer system is provided. The computing system may include a processor and associated memory storing instructions that when executed cause the processor to implement a plurality of artificial intelligence (AI) models, in which each AI model is configured to receive, as input, time series data and to output a model-specific time series forecast including a respective predicted value for each of a plurality of future time steps. The processor may be further configured to implement a model selection neural network configured to select a predicted most accurate AI model from among the plurality of AI models for each of the plurality of future time steps. The processor may be further configured to implement a blended output generator configured to output a model-blended time series forecast including the respective predicted value computed by the predicted most accurate AI model selected for each of the plurality of future time steps. The processor may be further configured to implement a reward function module configured to, in a training phase, train the model selection neural network using reinforcement learning via a reward function module that computes a reward or penalty value based on an error difference between the respective predicted value of the predicted most accurate AI model and an actual value for each of the plurality of future time steps.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A computer system, comprising:
a processor and associated memory storing instructions that when executed cause the processor to implement:
a plurality of artificial intelligence (AI) models, each AI model being configured to receive, as input, time series data and to output a model-specific time series forecast including a respective predicted value for each of a plurality of future time steps;
a model selection neural network configured to select a predicted most accurate AI model from among the plurality of AI models for each of the plurality of future time steps; and
a blended output generator configured to output a model-blended time series forecast including the respective predicted value computed by the predicted most accurate AI model selected for each of the plurality of future time steps.

2. The computer system of claim 1, wherein the plurality of AI models includes models that are configured to generate predicted values for future time steps of respective different output ranges.

3. The computer system of claim 2, wherein the respective different output ranges include a long-term output range, and a short-term output range that is shorter than the long-term output range.

4. The computer system of claim 2, wherein the respective different output ranges include 1.5 hour, 3 hour, 6 hour, and 24 hour ranges.

5. The computer system of claim 1, wherein, in a training phase, the model selection neural network is trained using reinforcement learning via a reward function module that computes a reward or penalty based on an error difference between the respective predicted value of the predicted most accurate AI model and an actual value for each of the plurality of future time steps.

6. The computer system of claim 5, wherein the reward function module specifies that a penalty is applied when the error difference is greater than a predetermined value.

7. The computer system of claim 5, wherein the model selection neural network is configured as a multi-armed bandit, each AI model being an arm of the multi-armed bandit.

8. The computer system of claim 1, wherein the time series data includes measurements of or from a wind sensor, sunlight sensor, rain sensor, temperature sensor, and/or barometric pressure sensor.

9. The computer system of claim 1, wherein the time series data includes measurements of historical data, weather monitoring station data, or satellite data.

10. The computer system of claim 1, further comprising:
an energy resource controller configured to receive the model-blended time series forecast, and
based upon the model-blended time series forecast, output a command affecting control, allocation, and/or optimization of an energy resource.

11. The computer system of claim 10, wherein the energy resource is selected from the group consisting of a solar array, wind turbine, hydroelectric generator and battery.

12. A computerized method, comprising:
implementing a plurality of artificial intelligence (AI) models;
receiving, via each AI model of the plurality of AI models, time series data as input;
outputting, via each AI model of the plurality of AI models, a model-specific time series forecast including a respective predicted value for each of a plurality of future time steps;
selecting, via a model selection neural network, a predicted most accurate AI model from among the plurality of AI models for each of the plurality of future time steps; and
outputting a model-blended time series forecast including the respective predicted value computed by the predicted most accurate AI model selected for each of the plurality of future time steps.

13. The method of claim 12, wherein the plurality of AI models includes models that are configured to generate predicted values for future time steps of respective different output ranges.

14. The method of claim 13, wherein the respective different output ranges include a long-term output range, and a short-term output range that is shorter than the long-term output range.

15. The method of claim 13, wherein the respective different output ranges include 1.5 hour, 3 hour, 6 hour, and 24 hour ranges.

16. The method of claim 12, further comprising:
training, in a training phase, the model selection neural network using reinforcement learning via a reward function module that computes a reward or penalty based on an error difference between the respective predicted value of the predicted most accurate AI model and an actual value for each of the plurality of future time steps.

17. The method of claim 16, wherein the reward function module specifies that a penalty is applied when the error difference is greater than a predetermined value.

18. The method of claim 12, wherein the time series data includes measurements of or from a wind sensor, sunlight sensor, rain sensor, temperature sensor, and/or barometric pressure sensor.

19. The method of claim 12, further comprising:
receiving, via an energy resource controller, the model-blended time series forecast, and
based upon the model-blended time series forecast, outputting a command affecting the control, allocation, and/or optimization of an energy resource.

20. A computer system, comprising:
a processor and associated memory storing instructions that when executed cause the processor to implement:
a plurality of artificial intelligence (AI) models, each AI model being configured to receive, as input, time series data and to output a model-specific time series forecast including a respective predicted value for each of a plurality of future time steps;
a model selection neural network configured to select a predicted most accurate AI model from among the plurality of AI models for each of the plurality of future time steps;
a blended output generator configured to output a model-blended time series forecast including the respective predicted value computed by the predicted most accurate AI model selected for each of the plurality of future time steps; and
a reward function module configured to, in a training phase, train the model selection neural network using reinforcement learning via a reward function module that computes a reward or penalty value based on an error difference between the respective predicted value of the predicted most accurate AI model and an actual value for each of the plurality of future time steps.
